(19) United States
(12) Patent Application Publication
(10) Pub. No.: US 2010/0180817 A1
(43) Pub. Date: Jul. 22, 2010

(54) PAINT ROLLER

(76) Inventor: Binyamin Atiya, Binyamina (IL)

Correspondence Address: YORAM TSIVION, P.O. BOX 1307, PARDES HANNA, 37111, IL

(21) Appl. No.: 12/668,027

(22) PCT Filed: Jul. 8, 2008
(86) PCT No.: PCT/IL08/00931

§ 371 Date: Jan. 7, 2010

(30) Foreign Application Priority Data
Jul. 9, 2007 (IL) 184491

(51) Int. Cl. B05C 17/02

(52) U.S. Cl. 118/258

(57) ABSTRACT

An improved paint roller (30) having a rotatable cylindrical body (37) and a paint-absorbing layer (36) wrapped peripherally around the cylindrical body (37). A handle (45) for holding the roller is attached to the pivot of rotation of the cylindrical body (37). The roller further includes an angular adjusting means (46) for angularly adjusting the handle. A member of a cylindrical frame (80) can be attached in a one end to the angular adjusting means and in a second end to the cylindrical body (37). A joining element (78) includes cylindrical members, a portion of the cylindrical members are insertable within the joining element (78).

### FIELD OF THE INVENTION

The present invention relates to a paint roller. More specifically the present invention relates to paint rollers for painting the upper parts of walls.

### BACKGROUND OF THE INVENTION

Paint rollers facilitate the efficient covering of large flat areas such as ceilings, walls, and even floors with a coat of paint or other substance. A paint roller typically includes a handle pivotally connected perpendicularly to a rolling element. The rolling element, referred to hereinafter as a roller head, has a superficial absorbing layer, typically a sponge. Prior to applying the paint to the wall, the paint-absorbing layer is dipped into a paint reservoir, rolled over to absorb paint on the entire circumference, and then applied by rolling over the target surfaces. For the major portion of the wall, this is an acceptable means for producing an even layer of paint; however difficulties arise in locations near a perpendicular adjacent wall, because the paint spreading rolling movements cause unnecessary paint to be applied to the perpendicular wall.

Therefore, a device which would allow the painter to paint freely in the corner area without damaging the ceiling with paint is called for.

U.S. Pat. No. 4,528,714 discloses an angularly adjustable paint roller in which the roller frame can be disposed at an angle of choice. The paint roller adapted to apply paint simultaneously to two perpendicular, intersecting surfaces.

### BRIEF DESCRIPTION OF THE DRAWINGS

FIG. 1 is isometric view of a paint roller in accordance with a preferred embodiment of the present invention resting upon a paint reservoir.

FIG. 2 is an isometric view showing the use of paint roller in accordance with a preferred embodiment of the present invention on a ceiling-wall junction corner zone;

FIG. 3 is an isometric view of a paint roller in accordance with an embodiment of the present invention adapted for painting walls near wall border tiles junction.

FIG. 4A is an isometric view of a paint roller in accordance with an embodiment of the present invention used for painting near walls border junction, wall-tiles border junction, and near ceiling-wall junctions.

FIG. 4B is an isometric view of a paint roller in accordance with an embodiment of the present invention used for painting near wall junctions, including a cap attached to the absorbing layer of the roller.

### DETAILED DESCRIPTION OF THE PRESENT INVENTION

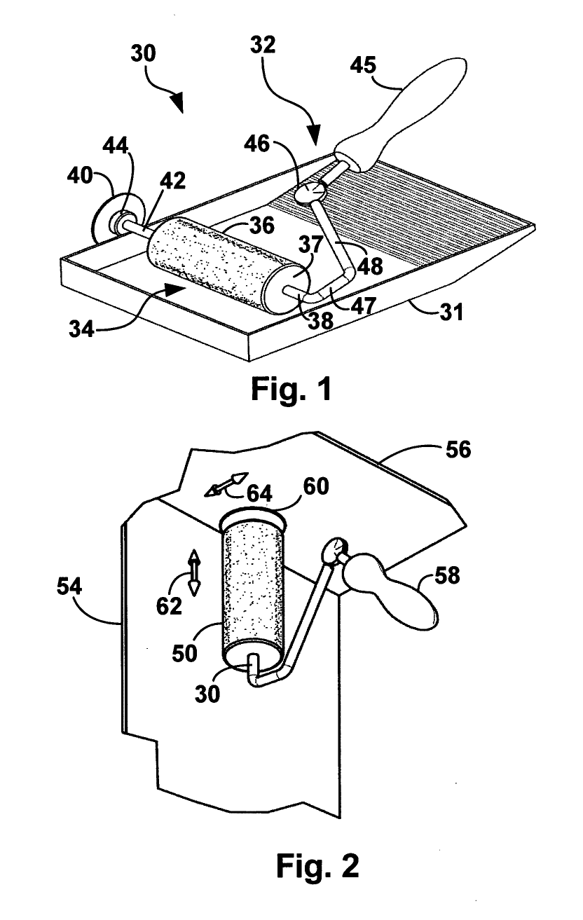

An isometric view of a paint roller in accordance with a preferred embodiment of the present invention is described schematically resting upon a paint reservoir in FIG. 1 to which reference is now made. Paint roller 30 resting upon paint reservoir 31 includes angularly adjustable portion (AAP) 32 and roller head portion 34. The roller head portion includes a superficial paint-absorbing layer 36 (PA), typically a sponge wrapped peripherally around cylindrical body (CB) 37. The CB and the attached PA 36 are rotatable around pivot 38. Disc 40 is attached to pivot 42 directly or through attaching disc 44, disc 40 has a certain freedom to disalign from the axis of pivot 42 while maintaining its rotatability. Pivot 42 has some freedom to move along its axis within CB 37 by a biasing means such as spring which is disposed inside CB 37. AAP 32 includes handle 45 and angular adjusting means 46 for angularly adjusting thereof. Spacing rod 47 and arm 48 extend the roller head from angular adjusting means 44. Arm 48 is secured to spacing rod 47. In some embodiments, pivot 42 and pivot 38 form a continuous shaft.

An isometric view showing the use of paint roller in accordance with a preferred embodiment of the present invention on a ceiling-wall junction corner zone is described in FIG. 2 to which reference is now made. The roller head's superficial paint-absorbing layer 50 is pressed against wall 54. Handle 58 is angularly adjusted against the wall to be easily handled by the user holding the roller. When the user grips handle 58 while forcing the roller towards the ceiling, disc 60 is pressed against the ceiling and the pivot attached to the disc is pressed into the cylinder, not shown in the drawing. Arrow 62 designates the pivot moving direction when pressing/releasing the roller head to/from the ceiling respectively. When the user grips roller handle 58 while forcing the roller to the wall such that the roller head is parallel to the wall, the disc is moves away from the pivot. Arrow 64 designates the disc's moving direction when pressing/releasing the roller head to/from the wall respectively.

Referring again to FIG. 1, in another aspect of the present invention, disc 40 is detachable. After the disc is removed, pivot 42 can be pressed inside the roller cylinder. Then, a lid is firmly placed on the CB to prevent biased pivot 42 from popping out of the CB. In yet another aspect of the present invention a handle extension is provided, with manually adjusted length.

In another aspect of the present invention disc 40 is wrapped with an absorbing layer such as sponge, synthetic fur or velvet. Wrapped disc 40 is used for painting on walls near wall junction corners by dipping the absorbing layer of disc 40 into a paint reservoir and then painting the zones near the junction corners.

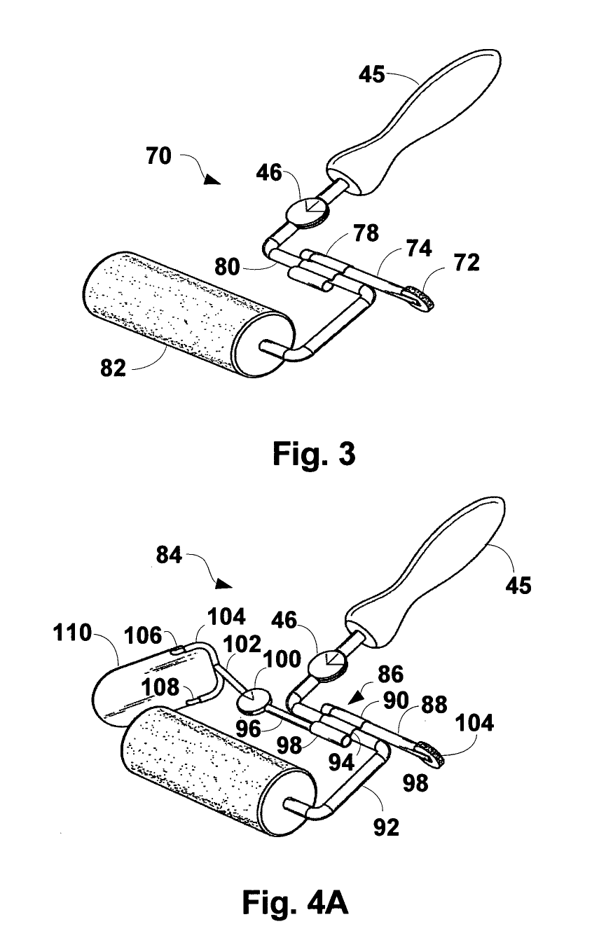

In accordance with another embodiment of the present invention a paint roller of the invention is adapted for painting walls near border tiles. An isometric view of a paint roller adapted for painting walls near border tiles is described in FIG. 3 to which reference is now made. Paint roller 70 includes pulley 72 which is pivotally connected to arm 74. Joining element 78 includes three juxtaposed hollow cylinders joined together. Joining element 78 is typically made of plastic or metal. Arm 74 is inserted partially in joining element 78, while cylindrical frame member 80 is inserted in the other component of joining element 78. The position of joining element 78 with respect to its inserts is not fixed unless one or two tightening elements, not shown, are used for temporarily affixing a respective insert to the joining element 78. When the paint roller is adapted for painting near wall border tiles, arm 74 and joining element 78 are adjusted such that while pulley 72 is rolled on the floor, absorbing layer 82 is rolled on the wall and above the wall border tiles.

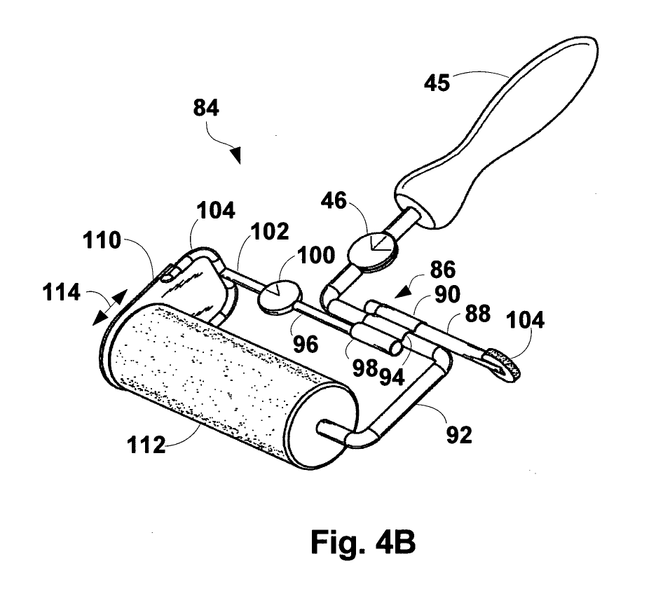

In accordance with another embodiment of the present invention a paint roller for painting near walls junction, wall-tiles junction and on ceiling-wall junction is provided. Referring to FIG. 4A, roller 84 includes joining element 86 which includes three juxtaposed hollow cylinders joined together, Typically they are made of plastic or metal. Arm 88 is partially inserted in cylindrical member 90 of joining element 86. Cylindrical frame member 92 is partially inserted in cylindrical member 94 of joining element 86 while arm 96 is partially inserted in cylindrical member 98 of joining element 86. The axial position of joining element 86 with respect to its inserts is not fixed unless one, two or three tightening elements, not shown, are used for temporarily affixing a respective insert to the joining element 86. Roller 84 further includes angular adjusting means 100 used for angularly adjusting arm 102 with respect to arm 96. In one end of arm 102 is attached a hollow cylindrical frame 104. Cylindrical frame members 106 and 108 support shield 110. Cylinders 106 and 108 have some freedom to move along its respective ends of frame 104 and are biased by means such as springs disposed inside both extremities of frame 104.

Referring to FIG. 4B, in situations in which roller 84 is used for painting on a ceiling-wall junction corner, shield 110 is inflected towards the bottom side of the absorbing layer 112 by moving arm 102. Arrow 114 designates the moving direction of the shield when pressing/releasing the roller head to/from the wall respectively. When the user grips roller handle 45 while forcing the roller forwards towards the wall, not shown, such that the roller head is parallel to the wall, the shield moves retracts backwards towards cylindrical hollow frame 104.

In situation in which the roller is to paint near wall-tiles junction, arm 88 is adjusted inside joining element 86 such that while pulley 104 is rolled on the floor, absorbing layer 101 is rolled on the wall and above the wall-tiles bordering the floor.

1. A paint roller comprising:
a cylindrical body (CB);
a paint-absorbing layer (PA) wrapped peripherally around said CB;
a pivot disposed along the axis of said CB and wherein said CB rotates around said pivot;
a biasing means for providing biasing to said pivot to the outside of said CB;
a handle;
an angular adjusting means for angularly adjusting said handle;
a spacing rod extends said PA from said angular adjusting means;
an arm secured to said spacing rod;
a disc revolvable around said pivot.

2. A paint roller as in claim 1 wherein the length of said handle is adjustable.

3. A paint roller device as in claim 1 wherein said disc is detachable.

4. A paint roller as in claim 1 wherein, said roller further comprises a lid disposed on one end of the roller opposite the roller end connected to said pivot and fasten to prevent said pivot from moving towards said lid.

5. A paint roller as in claim 1 wherein, said disc has a certain freedom to disalign from the axis of said pivot while keeping its rotatability.

6. A paint roller as in claim 1, wherein said disc is wrapped by an absorbing layer.

7. A paint roller comprising:
a rotatable cylindrical body (CB);
a paint-absorbing layer (PA) wrapped peripherally around said CB;
an axial pivot of rotation of said CB;
a handle for holding said roller, wherein said roller is attached to said pivot;
an angular adjusting means for angularly adjusting said handle;
a member of a cylindrical frame attached in one end to said angular adjusting means and in second end to said CB;
a joining element comprising cylindrical members into which at least one of said cylindrical members is insertable within.

8. A paint roller as in claim 6 wherein one end of an arm is inserted in a cylindrical member of said joining element and the other end of said arm is pivotally connected to a pulley.

9. A paint roller as in claim 7, further comprising at least one tightening element for temporarily affixing an insert to a respective cylindrical member of said joining element.

10. A paint roller as in claim 7, wherein a shield is attached to one end of an arm and wherein the second end of said arm is inserted inside said joining element.

11. A paint roller as in claim 10, further comprising a second angular adjusting means for angularly adjusting said arm.

12. A paint roller as in claim 10, further comprising a biasing means for biasing said shield.

13. A paint roller as in claim 10, wherein a second arm is inserted in cylindrical member of said joining element and wherein the other end of said arm is pivotally connected to a pulley.
